(19) United States
(12) Patent Application Publication
(10) Pub. No.: US 2025/0315604 A1
(43) Pub. Date: Oct. 9, 2025

(54) SYSTEMS AND METHODS FOR GENERATING DYNAMIC DOCUMENT TEMPLATES USING OPTICAL CHARACTER RECOGNITION AND CLUSTERING TECHNIQUES

(71) Applicant: State Farm Mutual Automobile Insurance Company, Bloomington, IL (US)

(72) Inventor: Alexander Gataric, Normal, IL (US)

(21) Appl. No.: 18/626,009

(22) Filed: Apr. 3, 2024

(51) Int. Cl. G06F 40/186; G06V 30/19

(52) U.S. Cl. CPC G06F 40/186; G06V 30/19093; G06V 30/19107

(57) ABSTRACT

A template generation and identification (TGI) system programmed to receive a batch of documents including a plurality of documents of different document types. The TGI system is also programmed to identify a plurality of text elements located within each document of the batch of documents. Each text element includes a text value. The TGI system is further programmed to analyze the text values for each text element of the plurality of text elements identified within each document to the text values for each text element of the plurality of text elements identified in other documents to determine a set of static text elements between at least a portion of the plurality of documents. In addition, the TGI system is programmed to generate a template that represents the at least a portion of the documents included within the batch of documents having matching sets of static text elements.

### FIELD OF DISCLOSURE

The present disclosure relates generally to dynamically generating document templates and, more particularly, to a network-based systems and methods for generating document templates using optical character recognition to analyze documents, using clustering to detect similarities in matching text values, and categorizing documents based upon comparisons with the templates.

### BACKGROUND

Documents are used to collect data for a variety of reasons. These documents may include form documents such as physical documents that people fill-out by hand or online forms that people fill-out by typing in responses. Additionally, online forms may include webforms, hosted on separate servers, and locally stored form fillable PDFs. In many industries, it is common for individuals be required submit multiple forms and other documentation. Examples include, but are not limited to, medical documentation, college applications, loan applications, insurance claims, and/or any other industry which generates multiple different documents that may need to be reviewed. These documents are intended to provide information relevant to the industry. Users may also have to fill-out other form documents that are submitted as part of the process. In the insurance example, policyholders may have to submit documents during an insurance claim process, such as a copy of a driver's license or insurance policy card, vehicle repair bills, medical bills, police reports, and the like.

In at least some cases, human personnel are tasked with identifying and reviewing these documents. These personnel must properly identify the type of document based on the information provided by each document. These tasks are tedious and prone to error. Some existing methods of automating document processing involve training a model using a dataset, which can involve significant modelling capabilities as well as significant computing resources to train and store such models.

### BRIEF DESCRIPTION OF THE DISCLOSURE

The present embodiments relate to systems and methods for generating document templates from a mixed set of document types. As described herein, a batch of documents of various document types are inputted into a template generation system. In the exemplary embodiment, the template generation system might not require any prior training or user-input identification of the document types. Rather, the template generation system is configured to operate “on-the-fly,” or dynamically, to generate any appropriate number of templates that may then be used to classify subsequent documents. Specifically, the template generation system of the present disclosure performs optical character recognition (OCR) on a plurality of documents to identify text elements found in the documents. The system generates a framework to represent each document based on text elements identified within each document. The frameworks are compared between documents, and, when enough matches are located, the documents are determined to be of the same document type. A template may then be generated when a threshold number of documents in a batch have been identified as the same type.

In one aspect, a template generation system for categorizing a variety of different documents is provided. The template generation system includes at least one memory with instructions stored thereon. The template generation system also includes at least one processor in communication with the at least one memory. The instructions, when executed by the at least one processor, cause the at least one processor to receive a batch of documents including a plurality of documents of different document types. The instructions also cause the at least one processor to identify a plurality of text elements located within each document of the batch of documents. Each text element includes a text value. The instructions further cause the at least one processor to analyze the text values for each text element of the plurality of text elements identified within each document to the text values for each text element of the plurality of text elements identified in other documents to determine a set of static text elements between at least a portion of the plurality of documents. Furthermore, the instructions cause the at least one processor to generate a template that represents the at least a portion of the documents included within the batch of documents having matching sets of static text elements. The system may have additional, less, or alternate functionality, including that discussed elsewhere herein.

In another aspect, a computer-implemented method of generating a template is provided. The method is implemented by a template generation server having a memory and a processor. The method includes receiving a batch of documents including a plurality of documents of different document types. The method also includes identifying a plurality of text elements located within each document of the batch of documents. Each text element includes a text value. The method further includes analyzing the text values for each text element of the plurality of text elements identified within each document to the text values for each text element of the plurality of text elements identified in other documents to determine a set of static text elements between at least a portion of the plurality of documents. Furthermore, the method includes generating a template that represents the at least a portion of the documents included within the batch of documents having matching sets of static text elements. The method may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a schematic diagram of an exemplary template generation and identification (TGI) system, in accordance with at least one embodiment.

FIG. 2 illustrates an exemplary template generation and identification server of the TGI system shown in FIG. 1 in further detail.

FIG. 3 illustrates an example of a document which may be input into the TGI system, shown in FIG. 1.

FIG. 4 illustrates a visual representation of a text element listing for a document including text elements as identified by the TGI system, shown in FIG. 1.

FIG. 5 illustrates a flow chart of an exemplary computer-implemented method for generating templates from an initial batch of documents using the TGB system, shown in FIG. 1.

FIG. 6 illustrates a flow chart of an exemplary computer-implemented method for processing documents after the initial batch is processed and templates have been generated.

FIGS. 7A and 7B illustrate a flow chart of an exemplary computer-implemented method 700 for processing documents shown in FIG. 2 to detect and quantify templates shown in FIG. 2.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments may relate to, inter alia, systems and methods for generating document templates using optical character recognition to analyze documents, using clustering to detect similarities in matching text values, and categorizing documents based upon comparisons with the templates. As used herein, “template” refers to a data structure representing the static data contained in the plurality of documents. As described further herein, the template is generated by comparing the text in a plurality of documents, determining similarities between static text values in the text, and identifying and/or creating templates based upon how similar the static text values are in between documents.

The systems and methods described herein overcome the deficiencies of other known systems, as described in greater detail herein. In one exemplary embodiment, the process may be performed by a template generation and identification (TGI) system. In the exemplary embodiment, the TGI system may be a web server associated with, for example, a company in need of the documents, such as those related to an individual.

For example, in order to process an insurance claim, an insurance provider (also referred to as an “insurer”) often receives many documents associated with the insurance claim. Given the volume of claims processed by an insurance provider, there may be a large number of documents received—either substantially continuously or in periodic batches, such as daily—which require further processing. It is contemplated that hundreds or thousands of documents, at least, may require processing, for classification and subsequent analysis. The herein described template generation and identification (TGI) system may be used with a plurality of different industries and for a plurality of different purposes. The example of insurance is purely cited as an example embodiment. One having skill in the art would understand that the systems and methods described herein would be usable with any of a plurality of different industries.

In the exemplary embodiment, the TGI system may receive a batch of documents including many different types of documents, such as, but not limited to, police reports, driver's licenses, insurance policy cards or other identifying documents, vehicle repair bills, medical bills, application forms, medical documents, loan applications, credit reports, tax forms, and the like. As used herein, a “batch” of documents may refer generally to a plurality of documents of various types that are processed in a same template-generation and/or template matching (e.g., classification) operation. Moreover, as used herein, different “types” of documents (e.g., “document types”) generally refers to documents which share a common format and form a subset of documents of the same type. For example, a W-2 tax form may be an example of a type of document. When that form is populated for five different individuals, those documents represent five instances of that type of document, as the documents of that type follow a common format but differ in some of the text included within the form. Those five documents may be considered a subset. As used herein, “subset” will generally refer to any group of documents which follow a similar format, and therefore, the documents are of the same document type. In many embodiments, documents of the same type may be slightly different. For example, an accident report form from the county police and an accident report form from the state police may include fields for much of the same information, but the formatting and location of those fields may be different. In at least one embodiment, the TGI system may detect the similarities of the two documents and categorize both as accident report forms, even though the two documents are from different jurisdictions and the same text elements are located in different locations on the corresponding forms.

When a batch of documents includes many different types of documents, it can complicate processing. If subsets of documents can be identified, wherein each document in a subset is of the same type and follows a similar format (e.g., “matches” or “substantially matches”), the automatic processing of the documents can be streamlined.

The TGI system as described herein includes a template generation and identification (TGI) server or computing device. Initially, the TGI server receives a batch of documents. The TGI server includes a text analyzer module. The text analyzer module performs optical character recognition (OCR) on each document and then scans the OCRed document and identifies text elements within the document. As used herein, “text elements” are individual instances of text appearing in a document. Each text element includes a text value and is associated with a document. Text elements may be individual words or a grouping of words identified by being spatially isolated or non-adjacent from other text elements. For example, a first text element may include the text value of “D.O.B.” and a second adjacent text element may include the text value of “Nov. 11, 1974.”

Each document may include static text values, which remain the same across a subset of documents, as well as dynamic text values, which are contextually responsive to associated static text values and may therefore change across instances of the document. Examples of static text values may include labels of fields commonly requested on documents such as “Name,” “Date of Birth,” “Phone Number,” etc. The text that is prompted to be filled in by the static text values in such fields, or that is contextually responsive to those field labels, is considered a variable text value. Based on the above example, the first text element “D.O.B.” would be considered a static text value, while the second text element would be considered a dynamic text value since it will change between forms. In some situations, a dynamic text value may appear to be a static text value based upon a plurality of forms including the same information in the corresponding text element.

A text detector module receives a batch of documents from data source or user computing device. As described above, the documents need not be of the same type. The text analyzer module performs optical character recognition (OCR) functionality to scan the text of the document to parse and extract text, which the text analyzer module organizes into text elements. The text elements include a text value and an association to a document. The text elements may be stored as individual rows in a database, such as database. Text elements are identified by the text detector module.

The text element comparison module receives text elements and identifies those text elements which have identical or substantially matching text values across the document objects. A substantial match of text values may include a fuzzy match. As used herein, “fuzzy match” refers to text values that substantially match, but accounts for minor differences introduced by typos, misspellings, variations in typing, or OCR. For example, one text value of “DOB” may be considered the equivalent of “D.O.B.,” as well as the equivalent of “date of birth” and other variations. These equivalent variations are considered the same for the purpose of fuzzy matches and for comparing documents. In some embodiments, the system allows for fuzzy matches. In other embodiments, the system only works with exact matches.

Furthermore, in at least one embodiment, OCR (optical character recognition) may have an error rate (i.e., 5%) for identification of text. Accordingly, the system accounts for the potential of errors in the OCR scan of any document. In these embodiments, the system recognizes and accounts for two documents not having the same set of static text elements and therefore, may not have a 100% match of static text elements, if the two documents are the same form. The system also accounts for these OCR errors in the clustering process.

In the exemplary embodiment, a text element comparison module determines which text elements have changing text values between documents (aka dynamic text elements) and which text elements have the same or similar text values between documents (aka static text elements). For example, in a form requiring a user to enter their name address would have static text elements that recite unchanging text values, such as, but not limited to, first name, last name, middle initial, street number, street address, city, state, country, county, and/or zip code. Filled out forms would also have dynamic text elements with different text values between different copies of the same form. A first form may have the street address of 123 Any Street, while another form has the street address of 321 Other Street. Some dynamic text elements may appear to be static text elements by having the same text values. For example, if all of the filled-out forms were for the same state (IL), then the text element comparison model may consider the filled in state value to be a static text element.

In the exemplary embodiment, fuzzy matches accounts for 15% of characters being misspelled. A Levenshtein function may be used to define fuzzy matches, such as from OCR errors. In some embodiments, the Levenshtein function is used during document identification. The text comparison module stores threshold criterion, and when these conditions are met, text comparison module defines a subset of static text elements. In some embodiments, such as during generation and template matching, the matching thresholds may need to be lowered if the input documents have a plurality of unstructured text and/or many variable fields. Template generation module receives the subsets and generates templates corresponding to each subset. In some further embodiment, a preliminary count of each text element (across all documents) is done and those below a certain threshold are deleted, which removes mode instances of names and other unique values with low counts. However, other text elements, such as a county name, may have a significant count.

The text element comparison module determines the number of static text fields that are the same and/or similar between different copies of forms. The text element comparison module tracks the static fields that match between different forms and builds the subsets of static text elements that match between multiple forms. While many forms may have some matching text elements between almost all of them, aka address fields, name fields, etc., there will also be static text elements that only match for forms of the same type. For example, a loan application form may be similar and have the same static text elements for multiple banks, jurisdictions, branches, etc., with the only major difference being the locations and/or sizes of the corresponding text elements. The text element comparison module tracks the number of matching static text elements and compares those numbers to thresholds to determine if there are enough matching static text elements to generate a template for the form. In the exemplary embodiment, the text element comparison module triggers the template generation module when the percentage of matching static text elements exceeds a predetermined threshold. The predetermined threshold may be set by one or more users and/or may be determined by machine learning. The predetermine threshold may also be set on the number of static text fields and/or other parameters set by the user and/or machine learning.

The text element comparison module compares the listing of text elements and their values for each document to determine whether there is an identical match or a substantial match between two or more of the documents. As used herein, “substantial match” will generally indicate that two documents match within an accepted degree or threshold level of confidence. The substantial match may be defined by a threshold number or percentage of overlap or match between two documents. A substantial match between two or more documents represents a match between the associated documents, or, in other words, a substantial match between two or more documents can be classified into a common category or type of document. In the exemplary embodiment, overlapping by 70% or more is considered to meet the threshold.

The text element comparison module stores (e.g., in a local cache for efficient reference) one or more threshold criterion that, when met, trigger the generation of a template. In the exemplary embodiment, the threshold criterion may include a document match percentage. As used herein, “document match percentage” refers to a percentage of text elements which match between two or more given documents. For example, text elements are aggregated for each document. A document match percentage can be determined by comparing each document to each other document and determining a document percentage match. The number of document match percentage may be user defined. In the exemplary embodiment, a document match percentage of 85% is required, and documents having a document match percentage less than 85% are removed from the preliminary subset. Once all documents meet or exceed the document match percentage, a final subset is defined.

The template generation module generates a template for each final subset identified. The template is defined as a common framework which includes the text elements which are common across each of the frameworks of the subset.

The TGI server is communicatively coupled to a database in which the TGI server stores the generated templates. The TGI server may also store or cache intermediate values used during the generation of the templates. For example, the template generation module stores the text elements identified in relation to each generated template. Additionally, or alternatively, the text detector module creates a separate table to store information for each input document. In some embodiments, the input document consists of the top page of the first page of the corresponding document. The comparison module stores the subsets of static text elements and templates in the database.

For any documents for which no matches are found, the template generation server may locally cache the documents. Unmatched documents may be used in an input set of a future template generation process.

Template generation server continuously receives new documents, matches those to existing templates, and generates new templates. As new batches of documents are received, template generation server identifies text elements and generates subsets of static text elements according to the previous description. However, prior to generating new templates, template generation server first checks to see if any of the documents identically or substantially match any existing templates. If no matching templates are found, template generation server continues according to the process previously describes, and the subsets of static text elements are compared to identify matching subsets and new templates may be generated.

In some embodiments, template generation system may rely upon text element counts to identify substantially matching documents. Text element counts of specific text elements which appear between two or more documents may help to identify a subset of documents. Similarly, overall work count between two or more documents may be used to confirm or identify a subset.

In some further embodiments, the template creation process may be application to TDI-created templates to generate groups of similar templates. For example, several types of police reports from the same state could be clustered into a template group. Other similar documents may be categorized together in the same template group.

Known methods of matching documents and generating templates that may involve machine learning or artificial intelligence require large amounts of data and computing resources. Notably, in many cases, machine learning requires utilizing a training set of data. For example, the training set may include a plurality of previously identified documents. The systems and methods described herein do not require any training prior to the input of a batch of documents. Therefore, the systems and methods described herein may be faster and may require significantly fewer computational resources than machine learning or artificial intelligence models.

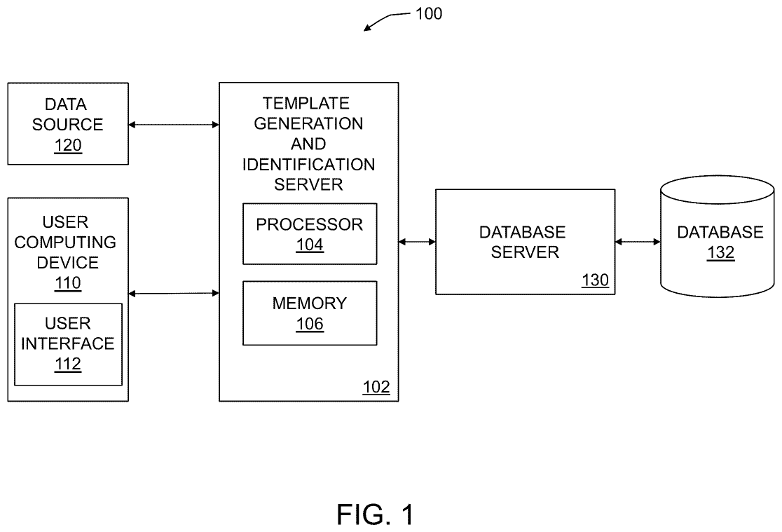

FIG. 1 illustrates a schematic diagram of an exemplary template generation and identification (TGI) system 100 for document processing. Template generation system 100 includes a template generation and identification (TGI) server 102 that is capable of receiving a batch of documents and generating templates. In the exemplary embodiment, TGI server 102 includes a processor 104 and a memory 106.

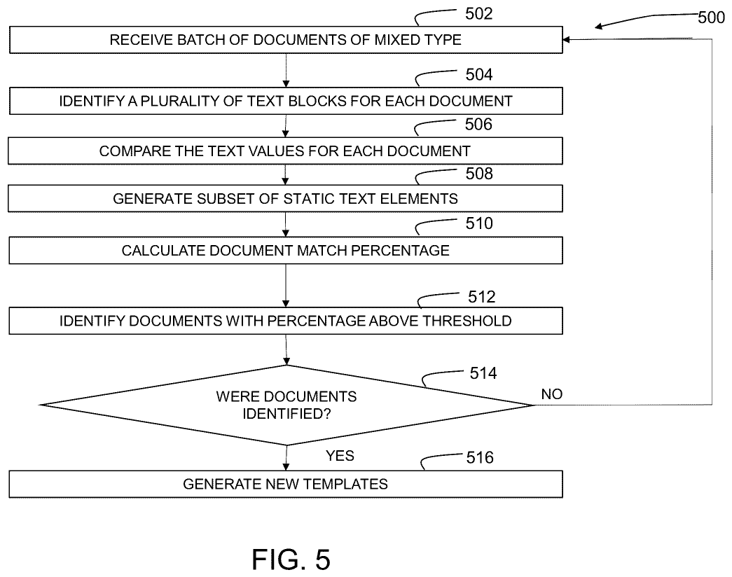

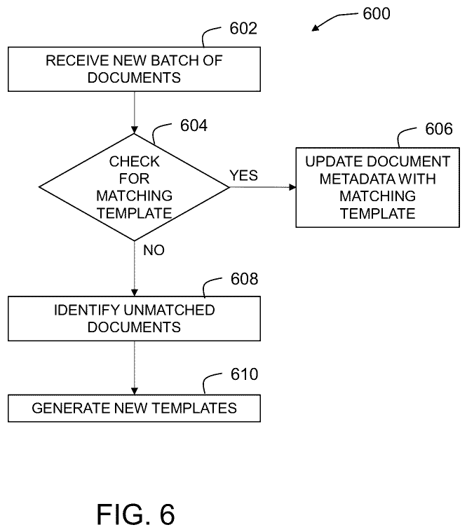

TGI server 102 is capable of implementing processes 500 and 600, shown in FIGS. 5 and 6, respectively. As described below in more detail, TGI server 102 is a computing device configured to receive a batch of documents, identify a subset of documents which include identical or substantially similar text elements, and generate a template for the identified subset of documents.

TGI server 102 may be in communication with at least one, but more likely many, user computing devices 110 that include a user interface 112. User computing devices 110 may be associated with a human claimant (e.g., policyholder), data analyst, loan officer, or other person submitting documents that require processing. The user of user computing device 110 may be prompted (e.g., via TGI server 102) to upload documents via user interface 112 of user computing device 110. In the exemplary embodiment, user computing devices 110 are computers that include a web browser or a software application, which enables user computing devices 110 to access remote servers, such as template generation server 102, the Internet, or other networks. More specifically, user computing devices 110 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computing device 110 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. User computing device 110 may be any personal computing device and/or any mobile communications device of a user, such as a personal computer, a tablet computer, a smartphone, and the like. User computing devices 110 may be configured to present an application (e.g., a smartphone “app”) or a webpage. To this end, user computing device 110 may include or execute software, such as a web browser, for viewing and interacting with a webpage and/or an app. Although one user computing device 110 is shown in FIG. 1 for clarity, it should be understood that TGI system 100 may include any number of user computing devices 110.

The TGI server 102 may also be in communication with a data source 120. Data source 120 may be associated with a company, such that the company may transmit a batch of documents requiring further processing to template generation server 102. Data source 120 may be any computing device as described above that is capable of transmitting the batch of documents to template generation server 102. Alternatively, template generation server 102 may receive documents from user computing device 110. In one example embodiment, the data source 120 may be associated with an insurance provider such that the insurance provider may transmit a batch of documents requiring further processing to template generation server 102.

In various embodiments, the TGI server 102 may be directly coupled to a database server 130 and/or communicatively coupled to database server 130 via a network. The TGI server 102 may, in addition, function to store, process, and/or deliver one or more web pages and/or any other suitable content to user computing device 110. The TGI server 102 may, in addition, receive data, such as data provided to the app and/or webpage (as described herein) from user computing device 110 for subsequent transmission to database server 130.

In some embodiments, the TGI server 102 may be associated with, or is part of, a computer network associated with an insurance provider, or in communication with insurer network computing devices. In other embodiments, TGI server 102 may be associated with a third party and is merely in communication with insurer network computing devices.

In some embodiments, the TGI server 102 may be associated with, or is part of, a computer network associated with a company performing data analysis, or in communication with company network computing devices. In other embodiments, TGI server 102 may be associated with a third-party and is merely in communication with company network computing devices.

Database server 130 may be any computer or computer program that provides database services to one or more other computers or computer programs. Database server 130 may function to process data received from template generation server 102.

Database 132 may be any organized collection of data, such as, for example, any data organized as part of a relational data structure, any data organized as part of a flat file, and the like. Database 132 may be communicatively coupled to database server 130 and may receive data from, and provide data to, database server 130, such as in response to one or more requests for data, which may be provided via a database management system (DBMS) implemented on database server 130, such as SQLite, PostgreSQL (e.g., Postgres), NoSQL, or MySQL DBMS. Database 132 may be a scalable storage system that includes fault tolerance and fault compensation capabilities. Data security capabilities may also be integrated into database 132. In one embodiment, database 132 may be Hadoop® Distributed File System (HDFS). In other embodiments, database 132 may be a non-relational database, such as APACHE Hadoop® database.

In the exemplary embodiment, database 132 may include various data, such as submitted documents, the document content associated therewith, as well as text elements, text values, threshold criterion, and generated templates, as described in further detail herein. In the exemplary embodiment, database 132 may be stored remotely from TGI server 102. In some embodiments, database 132 may be decentralized. In the exemplary embodiment, a user may access database 132 via user computing devices 110 by logging onto the TGI server 102, as described herein.

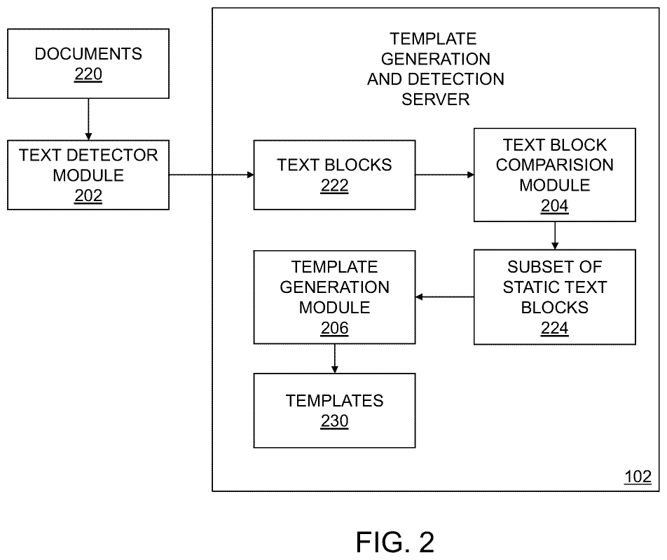

FIG. 2 is a diagram that illustrates template generation and identification (TGI) server 102 in further detail. The TGI server 102 includes a text detector module 202, a text element comparison module 204, and a template module 206. These modules may be implemented or executed using one or more processors 104.

The text detector module 202 receives a batch of documents 220 from data source 120 or user computing device 110, as shown in FIG. 1. As described above, the documents need not be of the same type. Text analyzer module 202 performs optical character recognition (OCR) functionality to scan the text of the document to parse and extract text, which text analyzer module 202 organizes into text elements 222. Text elements 222 include a text value and an association to a document. Text elements 222 may be stored as individual rows in a database, such as database 132 (shown in FIG. 1). Text elements 222 are identified by the text detector module 202.

The text element comparison module 204 receives text elements 222 and identifies those text elements which have identical or substantially matching text values across the document objects. A substantial match of text values may include a fuzzy match. As used herein, “fuzzy match” refers to text values that substantially match, but accounts for minor differences introduced by typos, misspellings, variations in typing, or OCR. For example, one text value of “DOB” may be considered the equivalent of “D.O.B.,” as well as the equivalent of “date of birth” and other variations. These equivalent variations are considered the same for the purpose of fuzzy matches and for comparing documents. In some embodiments, the system allows for fuzzy matches. In other embodiments, the system only works with exact matches.

Furthermore, in at least one embodiment, OCR (optical character recognition) may have an error rate (i.e., 5%) for identification of text. Accordingly, the system 100 accounts for the potential of errors in the OCR scan of any document 220. In these embodiments, the system 100 recognizes and accounts for two documents 220 not having the same set of static text elements 222 and therefore, may not have a 100% match of static text elements 222, even if the two documents 220 are the same form. The system 100 also accounts for these OCR errors in the clustering process.

In the exemplary embodiment, the text element comparison module 204 determines which text elements have changing text values between documents 220 (aka dynamic text elements) and which text elements have the same or similar text values between documents 220 (aka static text elements). For example, in a form requiring a user to enter their name address would have static text element that recite unchanging text values, such as, but not limited to, first name, last name, middle initial, street number, street address, city, state, country, county, and/or zip code. Filled out forms would also have dynamic text elements with different text values between different copies of the same form. A first form may have the street address of 123 Any Street, while another form has the street address of 321 Other Street. Some dynamic text elements may appear to be static text elements by having the same text values. For example, if all of the filled-out forms were for the same state (IL), then the text element comparison model 204 may considered the filled in state value to be a static text element.

In the exemplary embodiment, fuzzy matches accounts for 15% of characters being misspelled. A Levenshtein function may be used to define fuzzy matches. In some embodiments, the Levenshtein function is used during document identification. The text comparison module 204 stores threshold criterion, and when these conditions are met, text comparison module 204 defines a subset of static text elements 228. In some embodiments, such as during generation and template matching, the matching thresholds may need to be lowered if the input documents 220 have a plurality of unstructured text and/or many variable fields. Template generation module 206 receives the subsets 224 and generates templates 230 corresponding to each subset.

The text element comparison model 204 determines the number of static text fields that are the same and/or similar between different copies of forms. The text element comparison module 204 tracks the static fields that match between different forms and builds the subsets of static text elements that match between multiple forms. While many forms may have some matching text elements between almost all of them, aka address fields, name fields, etc., there will also be static text elements that only match for forms of the same type. For example, a loan application form may be similar and have the same static text elements for multiple banks, jurisdictions, branches, etc., with the only major difference being the locations and/or sizes of the corresponding text elements. The text element comparison module 204 tracks the number of matching static text elements and compares those numbers to thresholds to determine if there are enough matching static text elements to generate a template for the form. In the exemplary embodiment, the text element comparison module 204 triggers the template generation module 206 when the percentage of matching static text elements exceeds a predetermined threshold. The predetermined threshold may be set by one or more users and/or may be determined by machine learning. The predetermine threshold may also be set on the number of static text fields and/or other parameters set by the user and/or machine learning.

The text element comparison module 204 compares the listing of text elements and their values for each document 220 to determine whether there is an identical match or a substantial match between two or more of the documents 220. As used herein, “substantial match” will generally indicate that two documents 220 match within an accepted degree or threshold level of confidence. The substantial match may be defined by a threshold number or percentage of overlap or match between two documents 220. A substantial match between two or more documents 220 can be classified into a common category or type of document 220. In the exemplary embodiment, documents 220 overlapping by 70% or more are considered to meet the threshold.

The text element comparison module 204 stores (e.g., in a local cache for efficient reference) one or more threshold criterion that, when met, trigger the generation of a template. In the exemplary embodiment, the threshold criterion may include a document match percentage. As used herein, “document match percentage” refers to a percentage of text elements 222 which match between two or more given documents 220. For example, text elements 222 are aggregated for each document 220. A document match percentage can be determined by comparing each document 220 to each other document 220 and determining a document percentage match. The number of document match percentage may be user defined. In the exemplary embodiment, a document match percentage of 85% is required, and documents 220 having a document match percentage less than 85% are removed from the preliminary subset. Once all documents 220 meet or exceed the document match percentage, a final subset is defined.

The text element comparison module 204 compares the listing of text elements 222 and their values for each document 220 to determine whether there is an identical match or a substantial match between two or more of the documents 220. As used herein, “substantial match” will generally indicate that two documents 220 match within an accepted degree or threshold level of confidence. The substantial match may be defined by a threshold number or percentage of overlap or match between two documents 220. A substantial match between two or more documents 220 represents a match between the associated documents 220, or, in other words, a substantial match between two or more documents 220 can be classified into a common category or type of document 220. In the exemplary embodiment, overlapping by 70% or more is considered to meet the threshold.

The text element comparison module 204 stores (e.g., in a local cache for efficient reference) one or more threshold criterion that, when met, trigger the generation of a template 230. In the exemplary embodiment, the threshold criterion may include a document match percentage. As used herein, “document match percentage” refers to a percentage of text elements 222 which match between two or more given documents 220. For example, text elements 222 are aggregated for each document 220. A document match percentage can be determined by comparing each document 220 to each other document 220 and determining a document percentage match. The number of document match percentage may be user defined. In the exemplary embodiment, a document match percentage of 85% is required, and documents 220 having a document match percentage less than 85% the subset of static text elements 224. Once all documents 220 meet or exceed the document match percentage, a final subset of static text elements 224 is defined.

The template generation module 206 generates a template 230 for each final subset of static text elements 224 identified. The template 230 is defined as a common framework which includes the text elements 222 which are common across each of the frameworks of the subset 224.

The TGI server 100 is communicatively coupled to a database 132 in which the TGI server 100 stores the generated templates 230. The TGI server 100 may also store or cache intermediate values used during the generation of the templates 230. For example, the template generation module 206 stores the text elements 222 identified in relation to each generated template 230. Additionally, or alternatively, the text detector module 202 creates a separate table to store information for each input document 220. In some embodiments, the input document 220 consists of the top page of the first page of the corresponding document. The text element comparison module 204 stores the subsets of static text elements 224 and templates 230 in the database 132.

For any documents 220 for which no matches are found, the TGI server 100 may locally cache the documents 220. Unmatched documents 220 may be used in an input set of a future template generation process. Unmatched documents 220 may also be added to a set of input documents 220 for template generation module 206.

The TGI server 102 continuously receives new documents 220, matches those to existing templates 230, and generates new templates 230. As new batches of documents 220 are received, the TGI server 102 identifies text elements 222 and generates or updates subsets of static text elements 224 according to the previous description. However, prior to generating new templates 230, the TGI server 102 first checks to see if any of the documents 220 identically or substantially match any existing templates 230. If no matching templates 230 are found, the TGI server 102 continues according to the process previously describes, and the subsets of static text elements 224 are compared to identify matching subsets 224 and new templates 230 may be generated. As shown in FIG. 1, the TGI server 102 is communicatively coupled with database server 130 and database 132. The database 132 stores the documents 220, text elements 222, subsets of static text elements 224, thresholds and/or criterion, and/or the templates 230.

In some embodiments, the TGI system 100 may rely upon text element counts to identify substantially matching documents 220. Text element counts of specific text elements which appear between two or more documents 220 may help to identify a subset of documents 220. Similarly, overall work count between two or more documents 220 may be used to confirm or identify a subset 224.

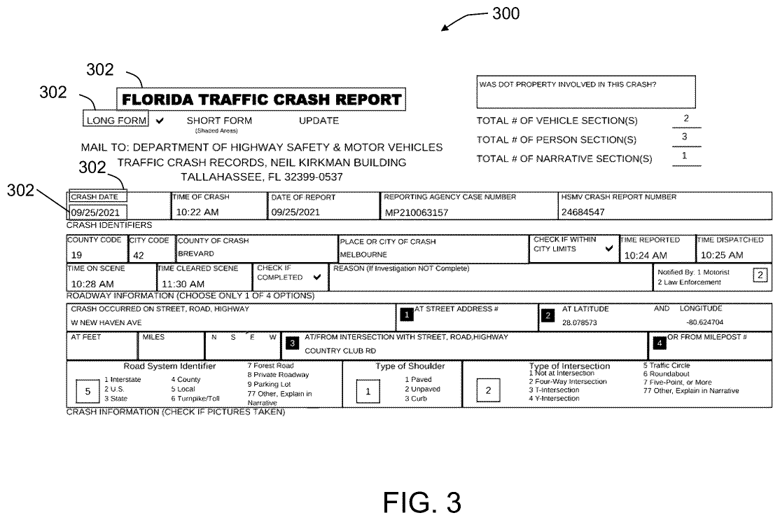

FIG. 3 illustrates an example of a document 300 which may be inputted into TGI system 100 (shown in FIG. 1). Document 300 may be similar to document 220 (shown in FIG. 2). Document 300 includes text elements 302, which are defined by a text value (which may be either a static text value or a variable text value). As described above, static text values are unchanged between documents 300 of the same type. Static text values may include the document title, field labels, or any other static portion of the template document. For example, “FLORIDA TRAFFIC REPORT,” “CRASH DATE,” “TIME OF CRASH,” and “DATE OF REPORT” represent static text values. Variable text values are portions of the document 300 which change between documents 300 of the same type. Variable text values are generally prompted to be filled in by the corresponding static text values. For example, “CRASH DATE” is the static text value, and “Sep. 25, 2021” is the corresponding variable text value.

The Template generation system 100 relies upon matching text values between documents to identify documents 300 of the same type. Static text values remain unchanged across instances of a particular type of document 300. Subsets 224 can be identified by focusing on documents which contain a substantial amount of matching text. In some embodiments, the TGI system may also utilize variable text values to identify documents of the same type. A threshold criterion is defined which determines the conditions which must be met in order to determine that a subset of documents match. TGI system 100 detects text elements 222 (shown in FIG. 2) including identified text elements, compares the text elements 222, and generates templates 230 when threshold criterion is met.

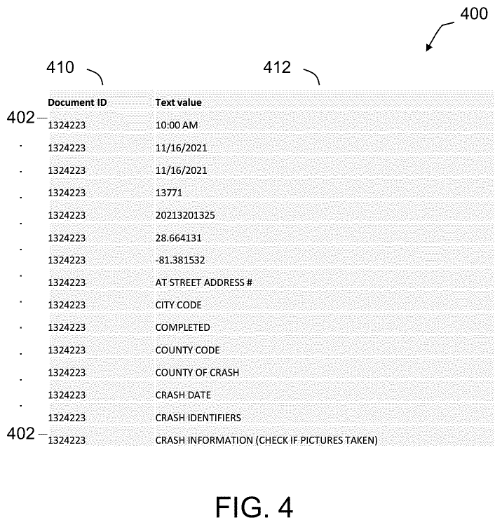

FIG. 4 illustrates a visual representation of a text element listing 400 for a document 220 including text elements 402 as identified by the TGI system 100 (shown in FIG. 1). As described above and shown in FIG. 2, text detector module 202 performs an OCR function and scans each input document 220 to identify text within the document 300 (shown in FIG. 3). In some embodiments, the input document 220 consists of the top page of the first page of the corresponding document. In some embodiments, the text element listing 400 may be similar to subset of static text elements 224 shown in FIG. 2). Text elements 402 may be similar to text elements 222 (shown in FIG. 2). Text detector module 202 identifies text, for instance, and then organizes the recognized text as text elements 402. Each text element 402 includes a text value (e.g., an OCR value). The TGI system 100 identifies a text element 402 which defines a section of text. The TGI system 100 may identify one or more words as a text element 402. For example, “AT STREET ADDRESS #” may be identified as a single text element 402, while a single word, “COMPLETED” may also be identified as a separate text element. The TGI system 100 may also use spacing and distance from other text elements 222 to identify individual text elements 222. In the exemplary embodiment, identified text elements 222 are stored in the database 132 (shown in FIG. 1).

Each text element 402 is represented as a row in the text element listing 400 shown here in FIG. 4. Each text element 402 includes a document ID 410 and a text value 412. As shown in FIG. 4, the document ID 410, and a document text value 412 correspond to each text element 402 identified in a document 220. The text element listing 400 is compared to each other text element listings 400 in order to identify matching text elements 402 between documents 220. Once the threshold criterion is met, indicating a match and a template 230 is created, a template ID and a template text value may be defined and assigned to each associated text element 402.

As previously discussed, the system and method utilize a small and simple set of data to perform template generation. Specifically, the system and method using text values 412 lead to faster processing times than other known methods. This eliminates the need for complex computing resources. Further, the system and method do not require a training step, which would require a training set of data. The TGI system 100 may generate templates 230 immediately upon receiving an initial batch of documents 220. Further, the TGI system 100 may store the results of the template generation of an initial batch, receive further batches, and either match the new documents 220 to existing templates 230 or create new templates 230.

FIG. 5 illustrates a flow chart of an exemplary computer-implemented process 500 for generating templates from an initial batch of documents 220 (shown in FIG. 2) using the TGI system 100 (shown in FIG. 1). In a first step, the TGI system 100 receives 502 a batch of documents of mixed document types. The batch of documents 220 may include any number of different types of documents 220.

The batch of documents 220 may include many different types of documents 220, such as, but not limited to, police reports, driver's licenses, insurance policy cards or other identifying documents, vehicle repair bills, medical bills, application forms, medical documents, loan applications, credit reports, tax forms, and the like. As used herein, a “batch” of documents 220 may refer generally to a plurality of documents 220 of various types that are processed in a same template-generation and/or template matching (e.g., classification) operation. Moreover, as used herein, different “types” of documents (e.g., “document types”) generally refers to documents 220 which share a common format and form a subset of documents 220 of the same type. For example, a W-2 tax form may be an example of a type of document 220. When that form is populated for five different individuals, those documents 220 represent five instances of that type of document 220, as the documents 220 of that type follow a common format but differ in some of the text included within the form. Those five documents 220 may be considered a subset. As used herein, “subset” will generally refer to any group of documents 220 which follow a similar format, and therefore, the documents 220 are of the same document type. In many embodiments, documents 220 of the same type may be slightly different. For example, an accident report form from the county police and an accident report form from the state police may include fields for much of the same information, but the formatting and location of those fields may be different. In at least one embodiment, the TGI system 100 may detect the similarities of the two documents 220 and categorize both as accident report forms, even though the two documents 220 are from different jurisdictions.

When a batch of documents 220 includes many different types of documents 200, it can complicate processing. If subsets of documents 220 can be identified, wherein each document 220 in a subset is of the same type and follows a similar format (e.g., “matches” or “substantially matches”), the automatic processing of the documents 220 can be streamlined.

In a second step, the TGI system 100 identifies 504 a plurality of text elements 402 (shown in FIG. 4) for each of the documents 220. In at least one embodiment, the TGI system 100 performs optical character recognition (OCR) on each of the documents 220 to identify text in the documents 220. The TGI system 100 scans each page of each document 220 to locate lines of text. Each line of text can be further parsed to identify text elements 402. Each text element 402 includes text value (e.g., an OCR value). As described above, the text elements 402 may be static text fields or dynamic text fields.

For each text element 402 identified, an entry is created in a database 132 (shown in FIG. 1), including the text value. The database 132 may store other information related to the text element 402 including document identification, page number, etc.

In a third step, the TGI system 100 compares 506 the text values in the text elements 222 in the various documents 220 for matches and/or similarities. In the exemplary embodiment, the TGI system 100 determines which text elements have changing text values between documents 220 (aka dynamic text elements) and which text elements have the same or similar text values between documents 220 (aka static text elements).

In a fourth step, the TGI system 100 generates 508 a subset of static text elements 224 for the various text boxes 222 that are static between documents 220. Each subset of static text elements 224 represents two or more documents 220 that have a plurality of similar or matching static text elements. In a fifth step, the TGI system 100 calculates 510 a document match percentage for groups of documents 220 associated with a subset of static text elements 224. In the sixth step, the TGI system 100 identifies 512 documents 220 with document match percentages over a threshold. In some embodiments, such as during generation and template matching, the matching thresholds may need to be lowered if the input documents 220 have a plurality of unstructured text and/or many variable fields. In the seventh step, the TGI system 100 determines 514 if any documents were identified with document match percentages over the threshold. If the answer is yes, then the TGI system 100 generates 516 one or more new templates 230 based upon the identified documents 220 and the corresponding subsets of static text elements 224.

In the exemplary embodiment, the TGI system 100 triggers the template generation module 206 when the percentage of matching static text elements 224 exceeds a predetermined threshold. The predetermined threshold may be set by one or more users and/or may be determined by machine learning. The predetermine threshold may also be set on the number of static text fields and/or other parameters set by the user and/or machine learning.

The text element comparison module 204 compares the listing of text elements 222 and their values for each document 220 to determine whether there is an identical match or a substantial match between two or more of the documents 220. As used herein, “substantial match” will generally indicate that two documents 220 match within an accepted degree or threshold level of confidence. The substantial match may be defined by a threshold number or percentage of overlap or match between two documents 220. A substantial match between two or more documents 220 can be classified into a common category or type of document 220. In the exemplary embodiment, documents 220 may match more than one template 230 at 70%. The highest matching template 230 is assigned to the document 220.

The text element comparison module 204 stores (e.g., in a local cache for efficient reference) one or more threshold criterion that, when met, trigger the generation of a template. In the exemplary embodiment, the threshold criterion may include a document match percentage. As used herein, “document match percentage” refers to a percentage of text elements 222 which match between two or more given documents 220. For example, text elements 222 are aggregated for each document 220. A document match percentage can be determined by comparing each document 220 to each other document 220 and determining a document percentage match. The number of document match percentage may be user defined. In the exemplary embodiment, a document match percentage of 85% is required, and documents 220 having a document match percentage less than 85% are removed from the preliminary subset. Once all documents 220 meet or exceed the document match percentage, a final subset is defined.

The generated templates 230 and identified subsets 224 may be used to identify documents 220 and aid in routing the documents 220 to the appropriate party. Once the type of document 220 is known, the document 220 may be routed more efficiently. As described above, the static text fields are used to identify text which remains the same across documents 220 of the same type, and the variable text fields are largely ignored. Once a document type is identified, the document 220 can be sent to an extraction process.

The method described above relates to receiving an initial batch of documents 220 and generating templates 230. However, there may be a need to receive additional batches after the initial batch has been processed. The data from the initial batch of documents 220 and the templates 230 generated may be retained in the database 132 and utilized when future batches are received. The documents 220 included in future batches may be matched to existing templates 230 or new templates 230 may be created. It is possible that not every document 220 of the initial batch was associated with a template 230. Unmatched documents may be retained in a table in the database 132 and considered along with future batches.

FIG. 6 illustrates a flow chart of an exemplary computer-implemented process 600 for processing documents 220 (shown in FIG. 2) after the initial batch is processed and templates 230 (shown in FIG. 2) have been generated. First, template generation system 100 receives 602 a new batch of documents 220. For each of the documents 220 in the new batch, the template generation system 100 identifies text elements 402 (shown in FIG. 4) according to the same methods described above. However, the documents 220 of the new batch are first compared to existing templates 230. Template generation server checks 604 for matching templates 230 by comparing the text elements 402 of the new documents 220 and determining a percentage match between the document 220 and one of the existing templates 230. If a match is found, the template generation system 100 applies 606 the template 230 to the matching document. The template 230 with the highest percentage match is returned as the matching template 230. If a match is not found, template generation system 100 identifies 608 unmatched documents 220. The unmatched documents 220 may include documents 220 from the initial batch, which have been retained in the database 132 (shown in FIG. 2), and documents 220 from the new batch. Finally, template generation system 100 generates 610 new templates 230 according to the methods described above for any documents 220 which have not been matched to an existing template 230.

In at least some embodiments any documents 220 which have not been assigned a template 230 may be retained in the database 132 and considered against any new batches of documents 220 received in order to generate new templates 230. The process is iterative, and templates 230 continue to be generated as new documents 220 are received.

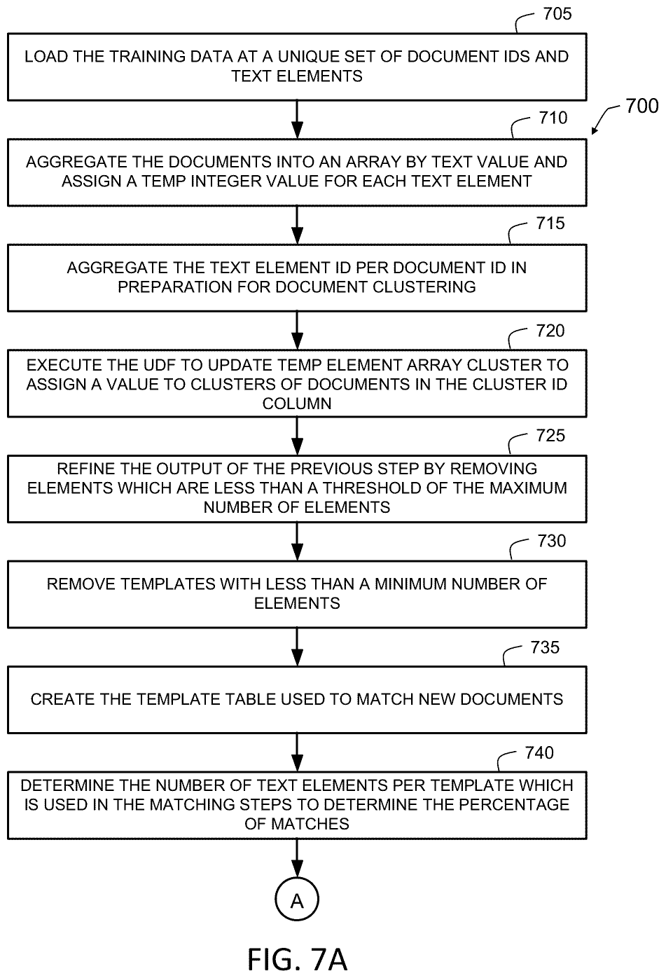

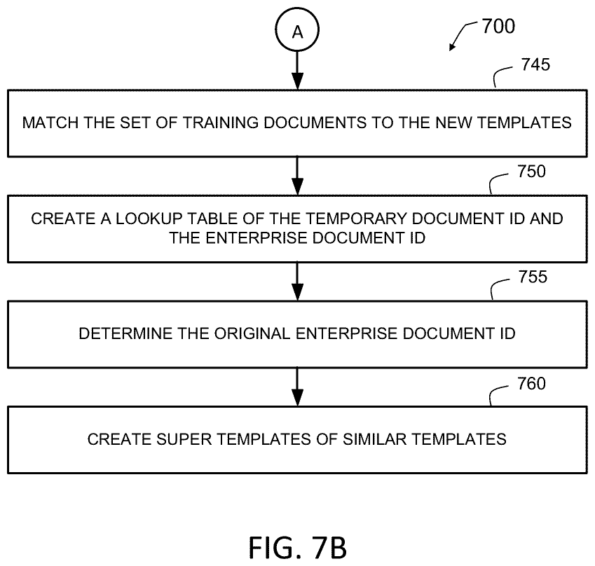

FIGS. 7A and 7B illustrate a flow chart of an exemplary computer-implemented method 700 for processing documents 220 (shown in FIG. 2) to detect and quantify templates 230 (shown in FIG. 2). In the exemplary embodiment, the steps of method 700 are performed by the TGI server 102 (shown in FIG. 1).

In the exemplary embodiment, the TGI server 102 loads 705 load the training data including a unique set of document IDs 410 and text elements 402 (both shown in FIG. 4).

In the exemplary embodiment, the TGI server 102 aggregates 710 the documents 220 into an array by text value 412 (shown in FIG. 4) and assign a temp integer value for each text element 402. The document array is unnested and inserted data into one or more elements, such as temp_text_document_element. The TGI server 102 removes text elements 402 with less than a predetermined value. This removes most highly variable elements right away.

In the exemplary embodiment, the TGI server 102 aggregates 715 the text element ID per document ID 410 in preparation for document clustering. The TGI server 102 inserts data into temp_element_array with the corresponding template_id set to zero to indicate an initial execution.

In the exemplary embodiment, the TGI server 102 executes 720 a UDF (user-defined function) to update temp element array cluster to assign a value to clusters of documents in the cluster ID column. In one embodiment, the TGI server 102 uses input parameters of 70% matching and 10 instances per text element 402. These values may vary depending on document type, such as police reports. The UDF is described in additional detail below.

In the exemplary embodiment, the TGI server 102 refines 725 the output of the previous step by removing text elements 402 which are less than a threshold of the maximum number of text elements 402. In one embodiment, the minimum number of text elements 402 is 85%. In other embodiments, the maximum number of text elements 402 may be set based upon the document type.

In the exemplary embodiment, the TGI server 102 remove 730 templates 230 with less than a minimum number of text elements 402. The minimum number of text elements 402 may be set based upon the document type. In at least one embodiment, the TGI server 102 inserts values into temp_element_array_template as template ID and an array of element_ID.

In the exemplary embodiment, the TGI server 102 creates 735 the template table used to match new documents 220. The TGI server 102 joins the template table to the temp_element_array_template to find the text value 412 for the temporary integer value assigned in step 710.

In the exemplary embodiment, the TGI server 102 determines 740 the number of text elements 402 per template 230, which is then used in for matching in step 745 to determine the percentage of matches.

In the exemplary embodiment, the TGI server 102 matches 745 the set of training documents 220 to the new templates 230. The TGI server 102 joins tables textract_template_values and textract_template_training by text value. The TGI server 102 also joins the tables to textract_template_element_count to determine the percentage of match.

In some embodiments, the TGI server 102 performs steps 750 and 755 to identify the best match if more than one template 230 matches. The TGI server 102 uses the matched documents to add descriptions to templates and in the super template process described later.

In the exemplary embodiment, the TGI server 102 creates 750 a lookup table of the temporary document ID 410 and the enterprise document ID.

In the exemplary embodiment, the TGI server 102 determines 755 the original enterprise document ID. This step joins textract_template_text_clustered_matches to template_lookup_enprs_doc_id_document_id so the original enterprise document ID is determined. This data can then be loaded into a matched document table.

In some embodiments, the TGI server 102 creates 760 super templates 230 of similar templates 230. This is useful to find templates which may be of the same category, such as, but not limited to different variations of the same type of police report. The TGI server 102 executes update_temp_element_array_cluster again with lower matching and instance values since there are many fewer templates than the initial set of documents.

As described further herein, the matching UDF document_template_match_array uses input parameters of an array of distinct text elements 402. In the exemplary embodiment, the best match is provided as a record. An example of the UDF includes:
cte_create_array as (select
document_id,array_agg (distinct text_value) as array_text_value
from dies4.textract_template_training
group by document_id
)
select document_id, (dies4.document_template_match_array (array_text_value)).* from cte_create_array

The functions include, but are not limited to, array_overlap_intarray, document_template_match_array, update_temp_element_array_overlap, update_temp_element_array_remove, and update_temp_element_array_cluster.

The function array_overlap_intarray returns the percentage of overlapping values in two integer arrays. It is used in the template clustering step to determine how similar arrays are.

The function document_template_match_array includes an input of an array of text values 412. The input text array and textract_template_training are joined by text value and further joined to textract_template_element_count to determine the percentage of match.

The function update_temp_element_array_overlap updates the temp_element_array with the template_id of overlapping arrays. The function starts with the first row in temp_element_array that has a template_id=0, which means that row hasn't been matched yet. This row is matched to every row in temp_element_array (with template_id=0, that are also unmatched) to see if array_element_id_int overlap by a given percentage. Table temp_element_array has the column template_id updated with the matching value.

The update_temp_element_array_remove function removes elements from clusters in temp_element_array which are below a certain threshold of the maximum element count of that cluster. Each cluster's array_element_id_int is unnested and the average number of instances of element per template_id is determined. The elements below threshold are removed from array_element_id_int and the number of rows updated is returned.

The update_temp_element_array_cluster function uses cycles through temp_element_array to find clusters and remove elements with low counts. The function update_temp_element_array_overlap is executed to generate clusters based on overlapping elements and update_temp_element_array_overlap is run to update the array to remove elements with few counts. There is a delete step to remove clusters with few elements. The process ends when update_temp_element_array_remove returns zero or the number of cycles reaches a maximum number of cycles, for example ten. This prevents runaway loops.

In some embodiments, the above process 700 may be used for testing and template creation and matching. The process 700 may be modified so that some steps are not truncated before each execution such as, but not limited to, textract_template_values, and textract_template_element_count.

### Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

In some embodiments, the TGI server 102 is configured to implement machine learning, such that the TGI server 102 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to documents with text. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of documents with text and/or other features. Such information may include, for example, information associated with a plurality of text elements and text fields in forms or other documents.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a large language model chatbot. The voice or chatbot may employ supervised or unsupervised machine learning techniques, which may be followed by, and/or used in conjunction with, reinforced or reinforcement learning techniques. The voice or chatbot may employ the techniques utilized for large language models. The voice bot, chatbot, large language model-based bot, large language models bot, and/or other bots may generate audible or verbal output, text or textual output, visual or graphical output, output for use with speakers and/or display screens, and/or other types of output for user and/or other computer or bot consumption.

Based upon these analyses, the processing element may learn how to identify characteristics and patterns that may then be applied to analyzing and classifying documents.

### EXEMPLARY EMBODIMENTS

In one aspect, a computer system may be provided. The computer system may include one or more local or remote processors, servers, sensors, memory units, transceivers, mobile devices, wearables, smart watches, smart glasses or contacts, augmented reality glasses, virtual reality headsets, mixed or extended reality headsets, voice bots, chat bots, ChatGPT bots, and/or other electronic or electrical components, which may be in wired or wireless communication with one another. For instance, the computer system may include at least one processor in communication with at least one memory device. The at least one processor may be configured to: (1) receive a batch of documents including a plurality of documents of different document types; (2) identify a plurality of text elements located within each document of the batch of documents, wherein each text element includes a text value; (3) analyze the text values for each text element of the plurality of text elements identified within each document to the text values for each text element of the plurality of text elements identified in other documents to determine a set of static text elements between at least a portion of the plurality of documents; and/or (4) generate a template that represents the at least a portion of the documents included within the batch of documents having matching sets of static text elements. The computer system may have additional, less, or alternate functionality, including that discussed elsewhere herein.

An enhancement of the system may include a processor configured to analyze the plurality of images based upon a plurality of user preference information. The images may be, for instance, retrieved from one or more memory units and/or acquired via one or more sensors, including cameras, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

A further enhancement of the system may include a processor configured to analyze the set of static text elements based upon one or more criterion to determine whether or not to generate the template.

A further enhancement of the system may include a processor configured to generate a set of static text elements for each comparison of two or more documents.

A further enhancement of the system may include a processor configured to perform optical character recognition on each of the plurality of documents.

A further enhancement of the system may include a processor configured to determine whether a first text element in a first document includes the same text value as a second text element in a second document.

A further enhancement of the system may include a processor configured to determine whether a first text element in a first document includes a matching text value as a second text element in a second document.

A further enhancement of the system may include a processor configured to identify static text values by comparing text values of documents to each other and applying a text element count to the most frequently repeated text values in the corresponding documents.

A further enhancement of the system may include a processor configured to determine a set of static text elements between at least a portion of the plurality of documents without identifying a location of any text element within the document.

A further enhancement of the system may include a processor configured to compare each document to each other document to determine a percentage match.

A further enhancement of the system may include where when the percentage match between two or more documents exceeds a threshold, the processor is configured to determine a set of static text elements between the two or more documents.

A further enhancement of the system may include a processor configured to receive a document of a first type. The processor may also be configured to identify a plurality of text elements located within the document. The processor may further be configured to analyze the text value for each text element of the plurality of text elements identified within the document in comparison to one or more stored templates including a template for the first type. Each template may be based upon a matching set of static text elements. In addition, the processor may be configured to categorize the document as the first type based upon matching a template of the first type.

A further enhancement of the system may include a processor configured to cache the document if no match is found.

A further enhancement of the system may include a processor configured to generate a document type for each generated template. The processor may also be configured to assign the document type to each corresponding document of the set of static text elements.

A further enhancement of the system may include a processor configured to store the template and the set of static text elements within a database.

In another aspect, a computer-implemented method may be provided. The computer-implemented method may be performed by a template generation computer device including at least one processor in communication with at least one memory device. The method may include: (1) receiving a batch of documents including a plurality of documents of different document types; (2) identifying a plurality of text elements located within each document of the batch of documents, wherein each text element includes a text value; (3) analyzing the text values for each text element of the plurality of text elements identified within each document to the text values for each text element of the plurality of text elements identified in other documents to determine a set of static text elements between at least a portion of the plurality of documents; and/or (4) generating a template that represents the at least a portion of the documents included within the batch of documents having matching sets of static text elements. The method may have additional, less, or alternate functionality, including that discussed elsewhere herein.

An enhancement of the computer-implemented method may include analyzing the plurality of images based upon a plurality of user preference information. The images may be, for instance, retrieved from one or more memory units and/or acquired via one or more sensors, including cameras, mobile devices, AR or VR headsets or glasses, smart glasses, wearables, smart watches, or other electronic or electrical devices; and/or acquired via, or at the direction of, generative AI or machine learning models, such as at the direction of bots, such as ChatGPT bots, or other chat or voice bots, interconnected with one or more sensors, including cameras or video recorders.

An enhancement of the computer-implemented method may include analyzing the set of static text elements based upon one or more criterion to determine whether or not to generate the template.

A further enhancement of the computer-implemented method may include generating a set of static text elements for each comparison of two or more documents.

A further enhancement of the computer-implemented method may include optical character recognition on each of the plurality of documents.

A further enhancement of the computer-implemented method may include determining whether a first text elements in a first document includes the same text value as a second text element in a second document.

A further enhancement of the computer-implemented method may include determining whether a first text element in a first document includes a matching text value as a second text element in a second document.

A further enhancement of the computer-implemented method may include identifying static text values by comparing text values of documents to each other and applying a text element count to the most frequently repeated text values in the corresponding documents.

A further enhancement of the computer-implemented method may include determining a set of static text elements between at least a portion of the plurality of documents without identifying a location of any text element within the document.

A further enhancement of the computer-implemented method may include comparing each document to each other document to determine a percentage match.

A further enhancement of the computer-implemented method may include where when the percentage match between two or more documents exceeds a threshold, the method further comprises determining a set of static text elements between the two or more documents.

A further enhancement of the computer-implemented method may include receiving a document of a first type. The method may also include identifying a plurality of text elements located within the document. The method may further include analyzing the text value for each text element of the plurality of text elements identified within the document in comparison to one or more stored templates including a template for the first type. Each template may be based upon a matching set of static text elements. In addition, the method may include categorizing the document as the first type based upon matching a template of the first type.

A further enhancement of the computer-implemented method may include caching the document if no match is found.

A further enhancement of the computer-implemented method may include generating a document type for each generated template. The method may also include assigning the document type to each corresponding document of the set of static text elements.

A further enhancement of the computer-implemented method may include storing template and the set of static text elements within a database.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are for example purposes only, and thus are not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “exemplary embodiment” or “one embodiment” of the present disclosure are not intended to be interpreted as excluding the existence of additional embodiments that also incorporate the recited features.

The patent claims at the end of this document are not intended to be construed under 35 U.S.C. § 112 (f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A template generation system for categorizing a variety of different documents, the template generation system comprising:
at least one memory with instructions stored thereon; and
at least one processor in communication with the at least one memory, wherein the instructions, when executed by the at least one processor, cause the at least one processor to:
receive a batch of documents including a plurality of documents of different document types;
identify a plurality of text elements located within each document of the batch of documents, wherein each text element includes a text value;
analyze the text values for each text element of the plurality of text elements identified within each document to the text values for each text element of the plurality of text elements identified in other documents to determine a set of static text elements between at least a portion of the plurality of documents; and
generate a template that represents the at least a portion of the documents included within the batch of documents having matching sets of static text elements.

2. The template generation system of claim 1, wherein the at least one processor is further programmed to analyze the set of static text elements based upon one or more criterion to determine whether or not to generate the template.

3. The template generation system of claim 1, wherein the at least one processor is further programmed to generate a set of static text elements for each comparison of two or more documents.

4. The template generation system of claim 1, wherein the at least one processor is further programmed to perform optical character recognition on each of the plurality of documents.

5. The template generation system of claim 1, wherein the at least one processor is further programmed to determine whether a first text element in a first document includes the same text value as a second text element in a second document.

6. The template generation system of claim 1, wherein the at least one processor is further programmed to determine whether a first text element in a first document includes a matching text value as a second text element in a second document.

7. The template generation system of claim 1, wherein the at least one processor is further programmed to identify static text values by comparing text values of documents to each other and applying a text element count to the most frequently repeated text values in the corresponding documents.

8. The template generation system of claim 1, wherein the at least one processor is further programmed to determine a set of static text elements between at least a portion of the plurality of documents without identifying a location of any text element within the document.

9. The template generation system of claim 1, wherein the at least one processor is further programmed to compare each document to each other document to determine a percentage match.

10. The template generation system of claim 9, wherein when the percentage match between two or more documents exceeds a threshold, the at least one processor is further programmed to determine a set of static text elements between the two or more documents.

11. The template generation system of claim 1, wherein the at least one processor is further programmed to:
receive a document of a first type;
identify a plurality of text elements located within the document;
analyze the text value for each text element of the plurality of text elements identified within the document in comparison to one or more stored templates including a template for the first type, wherein each template is based upon a matching set of static text elements; and
categorize the document as the first type based upon matching a template of the first type.

12. The template generation system of claim 11, wherein the at least one processor is further programmed to cache the document if no match is found.

13. The template generation system of claim 1, wherein the at least one processor is further programmed to:
generate a document type for each generated template; and
assign the document type to each corresponding document of the set of static text elements.

14. The template generation system of claim 1, wherein the at least one processor is further programmed to store the template and the set of static text elements within a database.

15. A computer-implemented method of generating a template, the method implemented by a template generation server comprising a memory and a processor, the method comprising:
receiving a batch of documents including a plurality of documents of different document types;
identifying a plurality of text elements located within each document of the batch of documents, wherein each text element includes a text value;
analyzing the text values for each text element of the plurality of text elements identified within each document to the text values for each text element of the plurality of text elements identified in other documents to determine a set of static text elements between at least a portion of the plurality of documents; and
generating a template that represents the at least a portion of the documents included within the batch of documents having matching sets of static text elements.

16. The computer-implemented method of claim 15 further comprising analyzing the set of static text elements based upon one or more criterion to determine whether or not to generate the template.

17. The computer-implemented method of claim 15 further comprising generating a set of static text elements for each comparison of two or more documents.

18. The computer-implemented method of claim 15 further comprising performing optical character recognition on each of the plurality of documents.

19. The computer-implemented method of claim 15 further comprising determining whether a first text elements in a first document includes the same text value as a second text element in a second document.

20. The computer-implemented method of claim 15 further comprising determining whether a first text element in a first document includes a matching text value as a second text element in a second document.

21. The computer-implemented method of claim 15 further comprising identifying static text values by comparing text values of documents to each other and applying a text element count to the most frequently repeated text values in the corresponding documents.

22. The computer-implemented method of claim 15 further comprising determining a set of static text elements between at least a portion of the plurality of documents without identifying a location of any text element within the document.

23. The computer-implemented method of claim 15 further comprising comparing each document to each other document to determine a percentage match.

24. The computer-implemented method of claim 23, wherein when the percentage match between two or more documents exceeds a threshold, the method further comprises determining a set of static text elements between the two or more documents.

25. The computer-implemented method of claim 15 further comprising:
receiving a document of a first type;
identifying a plurality of text elements located within the document;
analyzing the text value for each text element of the plurality of text elements identified within the document in comparison to one or more stored templates including a template for the first type, wherein each template is based upon a matching set of static text elements; and
categorizing the document as the first type based upon matching a template of the first type.

26. The computer-implemented method of claim 25 further comprising caching the document if no match is found.

27. The computer-implemented method of claim 15 further comprising:
generating a document type for each generated template; and
assigning the document type to each corresponding document of the set of static text elements.

28. The computer-implemented method of claim 15 further comprising storing the template and the set of static text elements within a database.
